(19) United States
(12) Patent Application Publication
(10) Pub. No.: US 2015/0228163 A1
(43) Pub. Date: Aug. 13, 2015

(54) ELECTRONIC GAMING MACHINE AND GAMING METHOD

(71) Applicant: Ainsworth Game Technology Limited, Newington (AU)

(72) Inventors: Peter Scott Clarebrough, Sydney (AU); Jason Meyer, Abbotsford (AU)

(21) Appl. No.: 14/614,398

(22) Filed: Feb. 4, 2015

(30) Foreign Application Priority Data
Feb. 7, 2014 (AU) 2014900377

(51) Int. Cl. G07F 17/34; G07F 17/32

(52) U.S. Cl. CPC G07F 17/34; G07F 17/3213; G07F 17/3244

(57) ABSTRACT

An electronic gaming machine has at least four bonus prizes associated with the electronic gaming machine. The bonus prizes are awarded upon the appearance of predetermined bonus prize combinations of game symbols. A first group of bonus prizes comprises two of the bonus prizes, each bonus prize of the first group being awarded upon the appearance of one or two of the bonus prize combinations. A second group of bonus prizes comprises two or more of the bonus prizes, each bonus prize of the second group being awarded upon the appearance of any one of three or more of the bonus prize combinations. Each of the bonus prize combinations are associated with only one of the bonus prizes. A gaming system and method are also provided.

### BACKGROUND

The invention relates to an electronic gaming machine and in a particular an electronic gaming machine employing a jackpot prize associated with a game played on the electronic gaming machine. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may also be provided by an electronic gaming machine in addition to a base or main game. Typically feature games use the same set of reels as the main game and are limited to a set of free games operated under a single set of rules. Once the free feature games have been played, the electronic gaming machine resets itself and returns the player back to the base game. This means that the feature game is restricted by the same set of rules, and so there is no variation in the play of the feature game.

Also, electronic gaming machines can offer one or more bonus prizes to the player during play of the game. Frequently, more than one jackpot is offered on the same game or on the same electronic gaming machine (the latter especially where more than one type of game is offered by the electronic gaming machine).

The most common type of bonus prize that is awarded by the electronic gaming machine is a jackpot prize, the main example of which is a progressive jackpot prize. A progressive jackpot prize takes a portion of each bet (typically a set percentage of each bet) made on the electronic gaming machine and thus the amount of the progressive jackpot inclemently increases as more bets are made on the electronic gaming machine. The progressive jackpot is typically awarded when a winning game combination associated with the jackpot occurs in the game played on the electronic gaming machine. In many cases, progressive jackpots are associated with the least probable winning combination and are commonly the highest paying award of the electronic gaming machine. In other forms of a progressive jackpot prize, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some electronic gaming machines, more than one jackpot or progressive jackpot is offered by the electronic gaming machine or electronic gaming machines linked together.

This standard structure to game play and bonus prizes limits the variation in the play of the electronic gaming machine. Consequently, it is difficult to retain player interest because there is no apparent incentive for the player to continue playing the same electronic gaming machine once the player becomes familiar with the feature game base game and jackpot prize features. Also, it is difficult to retain player interest since there is little differentiation between gaming machines in terms of the base and feature games that are played, and any associated jackpot or bonus prizes.

It is an object of the present invention to overcome or substantially ameliorate one or more of the disadvantages of prior art, or at least to provide a useful alternative. It is an object of the invention in at least one preferred form to provide an electronic gaming machine and gaming method that encourages player interest.

### SUMMARY

According to a first aspect of the invention, there is provided an electronic gaming machine comprising:

a display for displaying a game comprising game symbols, where predetermined winning combinations of randomly selected game symbols award prizes to a player, and

an electronic game controller for controlling the display of said game symbols for said game on said display,

wherein at least four bonus prizes are associated with said electronic gaming machine, said bonus prizes being awarded upon the appearance of predetermined bonus prize combinations of game symbols, and

wherein a first group of bonus prizes comprises two of said bonus prizes, each said bonus prize of said first group being awarded upon the appearance of one or two of said bonus prize combinations and wherein a second group of bonus prizes comprises two or more of the bonus prizes, each said bonus prize of said second group being awarded upon the appearance of any one of three or more of said bonus prize combinations, each of said bonus prize combinations being associated with only one of said bonus prizes.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

It will be appreciated that in the first aspect of the invention, the bonus prize combinations in the first group are different to the bonus prize combinations in the second group.

Preferably, said bonus prizes are associated with said game.

Preferably, each said bonus prize combination comprises a predetermined number of the same game symbol and a jackpot trigger symbol. More preferably, one of said bonus prize combinations comprises at least one wild card symbol. In one preferred form, said predetermined number is five for each said bonus prize combination in said first group. In another preferred form, said predetermined number ranges from 1 to 4 for each said bonus prize combination in said second group.

Preferably, one bonus prize of said first group is awarded only upon the appearance of one of said bonus prize combinations. More preferably, all of said bonus prizes of said first group are awarded only upon the appearance of one of said bonus prize combinations. In at least one preferred form, at least two bonus prizes in said second group are awarded upon the appearance of any one of five or more bonus prize combinations.

Preferably, the probability of said jackpot trigger symbol being displayed is proportional to a bet made by said player to play said game.

Preferably, each said bonus prize has a current value, said current value comprising a start up value and an incremented value, said incremented value increasing by a predetermined increment amount with each play of said game. More preferably, said predetermined increment amount is calculated according to a percentage of each bet made to play said game. In one preferred form, said game said bonus prizes have individual start up values and predetermined increment amounts. In a further preferred form, at least two of said bonus prizes have different start up values and predetermined increment amounts. In one particularly preferred form, said bonus prizes in said first group have start up values greater than the start up values of the bonus prizes in said second group.

Preferably, said electronic game controller causes the display of the current value of said associated bonus prize. More preferably, said electronic game controller causes the display of the bonus prize combinations for each said bonus prize.

Preferably, said bonus prizes of said first group are progressive jackpot prizes and said bonus prizes of said second group have fixed values. Alternatively, it is preferred that said bonus prizes of said first group have fixed values and said bonus prizes of said second group are progressive jackpot prizes. In a further alternative, it is preferable that said bonus prizes of said first group and said second group have fixed values.

It is preferred that said game comprises said randomly selected game symbols displayed in an array of predetermined game positions. More preferably, said game symbols are arranged into an array of reels. Where said game symbols are arranged into an array of reels, said jackpot trigger symbol only appears in one of said reels. In one preferred form, said jackpot trigger symbol only appears in an end reel of said array. In a particularly preferred form, there are five reels and said jackpot trigger symbol only appears in the rightmost reel of said array. In another particularly preferred form, there are six reels and said jackpot trigger symbol only appears in the rightmost reel of said array.

Preferably, said electronic gaming machine provides a plurality of said games, said games being associated with said bonus prizes. Alternatively, said electronic gaming machine provides a plurality of said games, and at least one of said bonus prizes is shared by two or more of said games. More preferably, all of said bonus prizes are shared by two or more of said games.

Preferably, at least one of said bonus prizes is one of a jackpot prize, a progressive jackpot prize or a mystery bonus prize.

Preferably, said electronic gaming machine comprises one or more additional bonus prizes that are not adjustable. More preferably, said electronic gaming machine comprises said additional bonus prizes and said bonus prizes. In one preferred form, said additional bonus prizes do not change in response to a bet level selected by said player.

Preferably, said reels comprises columns of predetermined game positions located substantially adjacent each other. Alternatively, said reels comprises rows of predetermined game positions located substantially adjacent each other. In one preferred form, said reels visually rotate to simulate rotation of a mechanical reel. In another preferred form, each said predetermined game position comprises an individual spinnable reel.

Preferably, said game comprises a base game and a feature game, wherein said one or more jackpot trigger symbols appear in said base game. Alternatively, said one or more jackpot trigger symbols appear in said feature game.

Preferably, the same game symbols are used in said feature game and said base game. Alternatively, different game symbols or a mixture of the same and different game symbols are used in said feature game and said base game.

Preferably, said feature game has the same number of game symbols as said base game. Alternatively, said feature game and said base game have different numbers of game symbols.

Preferably, the game symbols in said feature game and said base game are organised or arranged in the same way. In another preferred form, the game symbols in said feature game and said base game are organised or arranged differently to each other.

Preferably, said game symbols in said feature game and said base game are arranged in arrays of the same shape or type. Alternatively, said game symbols in said feature game and said base game are arranged in differently shaped arrays. The shapes of said arrays are preferably rectangular, circular, triangular, oval, semi-circular or other non-rectangular shape.

Preferably, said electronic game controller causes the display of said feature game in response to a feature game trigger event. Alternatively, said electronic game controller causes the display of said feature game and said base game during play of said base game, said feature game being inactive until triggered. In this preferred form, the change in said feature game from being inactive to active may be indicated on the display.

Preferably, said electronic game controller causes the display of said base game on a separate display to said display. Alternatively, said electronic game controller causes the display of said feature game and said base game on the same display.

Preferably, one or more game enhancing elements modify the result of a play of said game. More preferably, the game enhancing elements comprise at least one or more of a predetermined number of free games, an enhanced game, bonus prizes, collector symbols, a win multiplier, wild multipliers, bonus wilds, symbols that cause the award of additional free games, trigger symbols to retrigger the game or enhanced game, directly retriggering the game or enhanced game, held columns, random wild symbols, progressives, bonus credits, jackpot symbols, and one or more symbol replacements.

Preferably, the award of free games also triggers replacement of the game with the enhanced game, said enhanced game offering more types of game enhancing elements than said game. In one preferred form, said enhanced game modifies the free games played. More preferably, said game randomly awards one or more game enhancing elements that modify the result of each said free game.

Preferably, the player selectively starts and/or stops play of said game.

Preferably, said electronic gaming machine comprises a housing and an input device. It is preferred that said input device comprises one or more buttons on said housing, said buttons being in electronic communication with said electronic game controller to transmit player commands to said electronic game controller. More preferably, said buttons are arranged on a console of said housing. Alternatively or additionally, said input device comprises a touch sensitive surface on said display for receiving player commands, said touch sensitive surface being in electronic communication with said electronic game controller to transmit player commands to said electronic game controller.

Preferably, said housing comprises a value transfer mechanism for paying said prizes to said player using value in an amount equal to an awarded prize. More preferably, said value transfer mechanism also receives value from said player to initiate said bet. In one embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Preferably, the electronic gaming machine comprises a mobile electronic gaming device. More preferably, said mobile electronic gaming device comprises a handheld electronic device. In one preferred form, said handheld electronic device comprises a handheld electronic gaming device or a smart phone. Alternatively, said electronic gaming machine comprises a computer. More preferably, said computer is connected to a communication network.

A second aspect of the present invention provides an electronic gaming machine comprising:

a housing having a display for displaying game symbols for playing a game and an electronic game controller in electronic communication with said display for controlling the appearance of game symbols in said game on the display;

wherein said game comprises randomly displaying said game symbols and awarding prizes to a player for predetermined winning combinations of game symbols to a player; and

an input device for receiving commands from said player to operate said electronic gaming machine and initiate play of said game on said display, said input device being in electronic communication with said electronic game controller;

wherein said electronic game controller in response to a command from said player via said input device commences play of said game by randomly selecting game symbols and transmitting a signal to said display to display said randomly selected game symbols;

wherein said electronic game controller causes at least four bonus prizes to be associated with said electronic gaming machine, said bonus prizes being awarded upon the appearance of predetermined bonus prize combinations of game symbols on said display, and

wherein a first group of bonus prizes comprises two of said bonus prizes, each said bonus prize of said first group being awarded upon the appearance of one or two of said bonus prize combinations and wherein a second group of bonus prizes comprises two or more of the bonus prizes, each said bonus prize of said second group being awarded upon the appearance of any one of three or more of said bonus prize combinations, each of said bonus prize combinations being associated with only one of said bonus prizes.

This second aspect of the invention preferably has the preferred features of the first aspect of the invention stated above, where applicable.

A third aspect of the invention provides a gaming system comprising a plurality of electronic gaming machines of the first or second aspect of the invention, wherein said electronic gaming machines are in electronic communication with each other and said bonus prizes are associated with at least one game of each said electronic gaming machine.

Preferably, one or more of said bonus prizes are shared by two or more of said games on each said electronic gaming machine.

Preferably, said system further comprises a bonus prize controller in electronic communication with said electronic game controllers of said electronic gaming machines for controlling the display of said bonus prizes.

The gaming system preferably has the preferred features of the first aspect of the invention stated above, where applicable.

According to a fourth aspect of the invention, there is provided a gaming method for an electronic gaming machine comprising a display and an electronic game controller, the method comprising the steps of:

controllably displaying game symbols for playing a game, wherein said game comprises predetermined winning combinations of game symbols that award prizes to a player and at least one bonus prize associated with said electronic gaming machine;

associating at least four bonus prizes with said electronic gaming machine, said bonus prizes being awarded upon the appearance of predetermined bonus prize combinations of game symbols;

arranging said bonus prizes into a first group and a second group, wherein said first group comprises two of said bonus prizes, each said bonus prize of said first group being awarded upon the appearance of one or two of said bonus prize combinations, and wherein said second group comprises two or more of said bonus prizes, each said bonus prize of said second group being awarded upon the appearance of any one of three or more of said bonus prize combinations, and

associating each of said bonus prize combinations with only one of said bonus prizes.

Preferably, said method comprises associating said bonus prizes with said game.

Preferably, said method comprises awarding one bonus prize of said first group only upon the appearance of one of said bonus prize combinations. More preferably, said method comprises awarding all of said bonus prizes in said first group only upon the appearance of one of said bonus prize combinations. In one preferred form, said method comprises awarding at least two bonus prizes in said second group upon the appearance of any one of five or more bonus prize combinations.

Preferably, determining the appearance of said jackpot trigger symbol based on a probability that is proportional to a bet made by said player to play said game.

Preferably, said method comprises displaying a current value of each said bonus prize, wherein said current value comprises a start up value and an incremented value, the method comprising increasing said incremented value by a predetermined increment amount with each play of said game. More preferably, said method comprises calculating said predetermined increment amount according to a percentage of each bet made to play said game. In one preferred form, said game comprises a plurality of said bonus prizes, the method comprising allocating individual start up values and predetermined increment amounts for each said bonus prize. In a particularly preferred form, wherein said allocating step comprises allocating have different start up values and predetermined increment amounts to at least two of said bonus prizes. In a further particularly preferred form, said allocating step comprises allocating start up values for said bonus prizes in said first group greater than the start up values for bonus prizes in said second group.

Preferably, said method comprises displaying said game symbols in an array of reels and causing said jackpot trigger symbol to only appear in one of said reels. In one preferred form, said jackpot trigger symbol only appears in an end reel of said array. In one particularly preferred form, there are five reels and said jackpot trigger symbol only appears in the rightmost reel of said array. In another particularly preferred form, there are six reels and said jackpot trigger symbol only appears in the rightmost reel of said array.

Preferably, said method comprises configuring one or more of said bonus prizes as one of a jackpot prize, a progressive jackpot prize and a mystery bonus prize.

Preferably, said method comprises providing a plurality of said games on said electronic gaming machine and associating said games to said bonus prizes.

The method preferably has the preferred features of the first aspect of the invention stated above, where applicable.

A fifth aspect of the present invention provides a gaming method for an electronic gaming machine comprising a housing having a display for displaying a game, wherein said game comprises game symbols and predetermined winning combinations of randomly selected game symbols in said game award prizes to a player; an electronic game controller inside said housing for controlling the display of said game symbols for playing said game on said display; and an input device for receiving commands from said player to operate said electronic gaming machine, said input device being in electronic communication with said electronic game controller, the method comprising:

said electronic game controller receiving a command from said player via said input device to initiate play of said game on said display;

said electronic game controller controllably displaying a game;

said electronic game controller associating at least four bonus prizes with said electronic gaming machine, said bonus prizes being awarded upon the appearance of predetermined bonus prize combinations of game symbols on said display;

said electronic game controller arranging said bonus prizes into a first group and a second group, wherein said first group comprises two of said bonus prizes, each said bonus prize of said first group being awarded upon the appearance of one or two of said bonus prize combinations, and wherein said second group comprises two or more of said bonus prizes, each said bonus prize of said second group being awarded upon the appearance of any one of three or more of said bonus prize combinations; and

said electronic game controller associating each of said bonus prize combinations with only one of said bonus prizes.

The method of the fifth aspect of the invention preferably has the preferred features of the fourth aspect of the invention stated above, where applicable.

A sixth aspect of the invention provides a gaming method for operating a plurality of electronic gaming machines in electronic communication with each other, comprising the gaming method of the fourth or fifth aspects of the invention, and associating said bonus prizes with at least one game of each said electronic gaming machine.

The method preferably has the preferred features of the fourth aspect of the invention stated above, where applicable.

According to a seventh aspect of the invention, there is provided a computer system comprising a central processing unit configured for communication with an electronic gaming machine, wherein said computer system is configured to perform the method of the fourth, fifth or sixth aspects of the invention.

According to a eighth aspect of the invention, there is provided a computer program configured to perform the method of the fourth, fifth or sixth aspects of the invention.

According to a ninth aspect of the invention, there is provided a non-transitory carrier medium carrying computer executable code that, when executed on a central processing unit configured for communication with an electronic gaming machine, causes the central processing unit to perform the method of the fourth, fifth or sixth aspects of the invention.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to an embodiment of the invention;

FIG. 2 is a schematic drawing of an electronic game controller for the electronic gaming machine of FIG. 1, and

FIG. 3 is a simulated screen shot of a game played on the electronic gaming machine of FIG. 1.

### DETAILED DESCRIPTION OF VARIOUS EMBODIMENTS

The present invention will now be described with reference to the following examples which should be considered in all respects as illustrative and non-restrictive. In the Figures, corresponding features within the same embodiment or common to different embodiments have been given the same reference numerals.

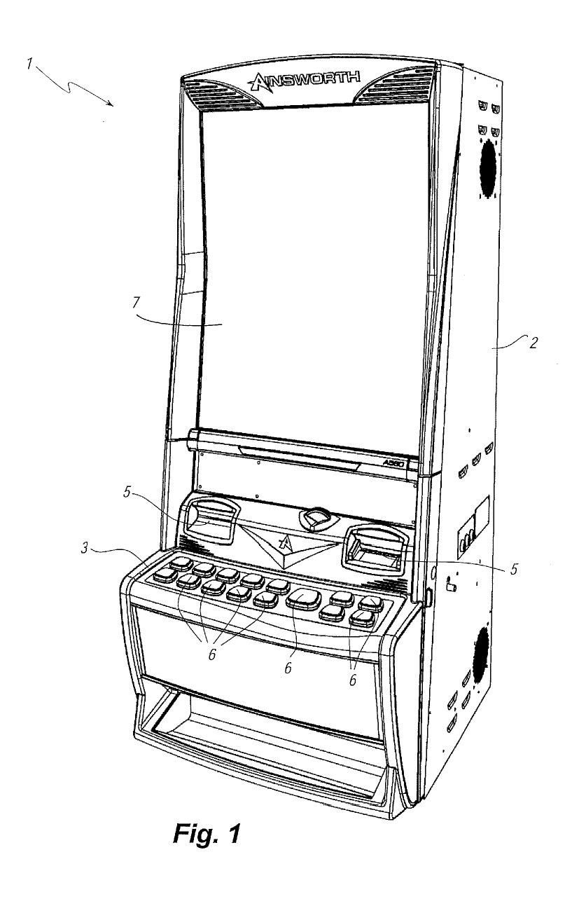

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value.

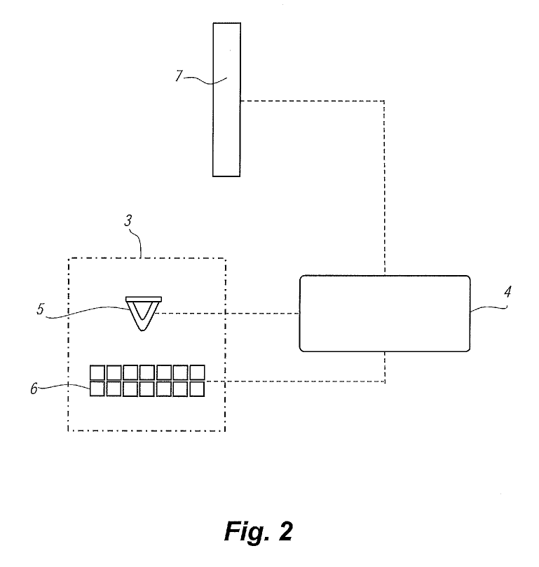

The electronic game controller 4 is generally in the form of a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store program instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value to be added to the electronic gaming machine 1.

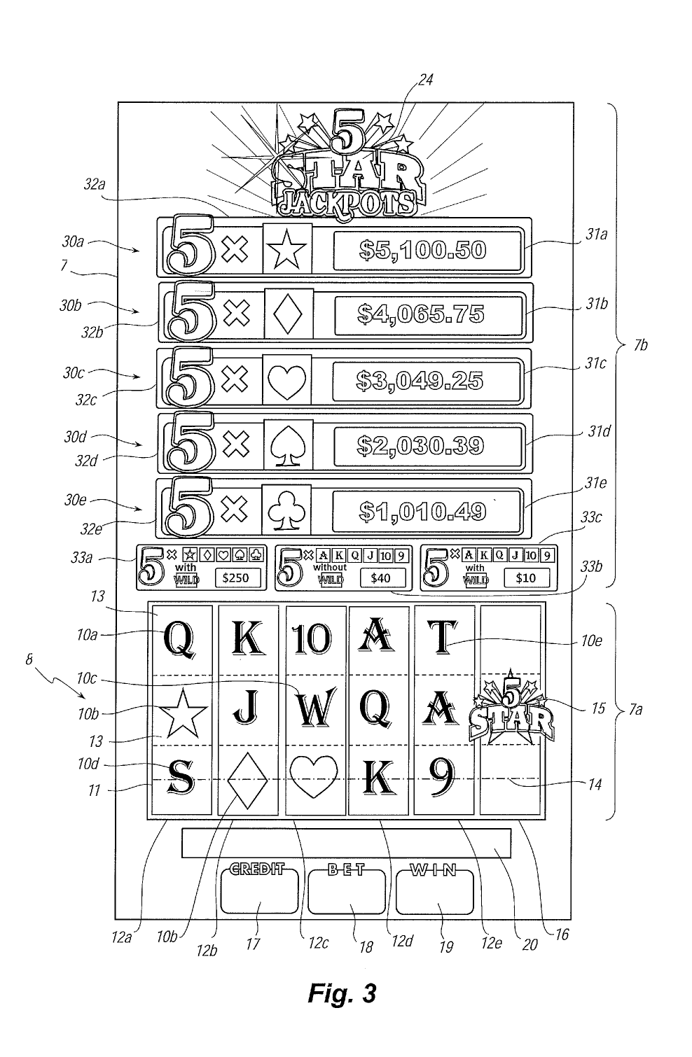

The electronic game controller 4 is programmed to provide a game in the form of a base game 8, as best shown in FIG. 3, and a feature game (not shown) on the video display screen 7 of the electronic gaming machine 1 for play by a player. The video display screen 7 is divided into a lower playing area 7a and an upper information display area 7b.

The base game 8 has game symbols 10 arranged into an array 11 in the form of five columns or “reels” 12 that are displayed in the lower playing area 7a, as best shown in FIG. 3. The reels 12 give the visual appearance of rotating, typically by having the game symbols 10 move in a downward linear path along the length of each reel 12. While the array 11 is arranged with five reels 12a, 12b, 12c, 12d, 12e and three rows as per the industry standard, it will be appreciated by one skilled in the art that other types of arrays and array formats could be used, such as 3×3, 4×3, 5×5, 4×4, etc, including arrays having an irregular number of rows and/or columns. For example, the array 11 can have an unequal number or rows and/or columns, where some columns have less or more rows than other columns or where some rows have less or more columns than other rows. A more specific example would be an array having three columns with only two rows and two columns with three rows. Another example would be an array having five reels of which two reels only have three rows while three reels have four rows. In some embodiments, the array 11 has an irregular shape. The electronic game controller 4 will transmit signals to the display screen 7 to cause the base game 8 and feature game to be played on the lower playing area 7a, including showing the game symbols 10, array 11 and other visible elements of the games.

The array 11 of the base game 8 defines predetermined symbol positions 13 in which the game symbols 10 appear. The symbol positions 13 are not visually marked by boundary lines and simply provide an area for the game symbols 10 to appear. However, it will be appreciated that in other embodiments, the symbol positions 13 are defined by visible boundary lines (to define “squares”, cells or game positions) or other markings to define each respective area of the symbol positions. The array 11 is arranged so that a player can select one or more predetermined “pay lines” 14 defined around the array, which correspond to combinations of the symbol or game positions 13. The pay lines 14 correspond to the lines selectable by the player and generally comprise at least one symbol or game position symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player. In the feature game, predetermined winning combinations of randomly selected game symbols 10 also result in the award of prizes to the player, usually of an enhanced value compared to the prizes awarded in the base game 8.

The game symbols 10 can include a mixture of picture symbols (such as animal symbols or playing card symbols), word symbols, scatter symbols, substitute or wild card symbols and trigger symbols. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event or confers an award, where the trigger symbol may or may not have to appear in combination and may or may not have to appear on the same player-selected pay line 14. In this embodiment, the game symbols 10 include playing card symbols 10a, picture or item-themed symbols 10b (such as star, heart, circle, triangle and diamond shaped symbols), substitute or wild card “W” symbols 10c, a scatter symbol in the form of “S” symbol 10d and a trigger symbol in the form of “T” symbol 10e that triggers the feature game. There is also another trigger symbol in the form of the “5 Star” symbol 15 that only appears on a special reel 16 located adjacent the reels 12. This “sixth” reel 16 need not be adjacent to the reels 12 and can appear elsewhere on the video screen 7. In addition, the special reel 16 only shows either the trigger symbol 15 to act as a jackpot/bonus “trigger” or blank symbol positions 13 that have no effect.

The electronic game controller 4 randomly determines and causes the appearance of the game symbols 10 on the array 11 in the symbol positions 13 of the reels 12 and the trigger symbol 15 in the cells of the special reel 16.

The video screen 7 also displays other standard game information in the lower playing area 7a, including the amount of player credits 17, the amount of the current bet wagered by the player 18, the amount of wins by the player 19 and a message area 20. Other game information includes the number of pay lines available, the number of player-selected pay lines, a current denomination button indicating the currently selected base bet denomination and the name of the game.

In the upper display area 7b, the video display screen 7 also displays the name 24 of the game “5 Star Jackpots” being played, as well as prize information about several bonus prizes in the form of jackpots 30 associated with the base game 8 and/or electronic gaming machine 1, as best shown in FIG. 3. To avoid player confusion, where more than one game is provided by the electronic gaming machine 1, it is preferred that the same jackpots 30 are provided for each game. In some embodiments, the upper display area 7b may also display an animated title or feature screen for the game and/or information relating to the rules for the base game 8 and feature games. This includes information outlining the key characteristics of the base game 8 and feature games.

The jackpots 30 comprise five separate jackpots each with associated jackpot prize images 30a, 30b, 30c, 30d and 30e, each comprising prize boxes 31a, 31b, 31c, 31d and 31e indicating their current value and parameter boxes 32a, 32b, 32c, 32d and 32e indicating the winning conditions or parameters for each jackpot prize. The jackpots 30a to 30e have different current values to reflect the difficulty in obtaining the necessary parameters to win the respective jackpot. Hence, jackpot 30a is the rarest as it has the highest current value of $5,100.50 as indicated in prize box 31a, whereas the jackpot 30e has the lowest current value of $1,010.49 as indicated in prize box 31e. Jackpots 30b, 30c and 30d are between these extremes, with the jackpot 30b having a current value of $4,065.75 as indicated in prize box 31b, jackpot 30c having a current value of $3,049.25 as indicated in prize box 31c and jackpot 30d having a current value of $2,030.39 as indicated in prize box 31d.

The current value shown in the prize boxes is the sum of an initial start up value and an incremented value. In this embodiment, the start up values are different for the jackpots 30a to 30e, jackpot 30a having an start up value of $5,000, jackpot 30b having an start up value of $4,000, jackpot 30c having an start up value of $3,000, jackpot 30d having an start up value of $2,000 and jackpot 303 having an start up value of $1,000. The incremented values are initially zero for each jackpot 30a to 30e. It will be appreciated that in other embodiments, the start up value is the same for each jackpot 30a to 30e. In yet other embodiments, some of the jackpots 30a to 30e have the same start up value and some of the jackpots 30a to 30e have different start up values.

With each play of the base game 8, the incremented value increases and is added to the current value of each jackpot 30a to 30e. The increase in the incremented value is typically a predetermined amount or calculated at a predetermined rate. Thus, as the base game 8 is continually played the current value of each prize box 31a to 31e incrementally or gradually increases until the jackpots 30a to 30e are won on the electronic gaming machine 1. Moreover, the jackpots 30a to 30e each have different incremented values so that their respective amounts vary over multiple plays of the game 8. The different incremented values can be either due to different incremented amounts and/or increment rates. Thus, unlike conventional electronic gaming machines where the jackpots share a common jackpot pool and/or incremented amount or increment rate, the jackpots 30a to 30e are separated from each other. Thus, the electronic gaming machine 1 provides a variety in game play not achieved in other gaming machines and thus encourages player interest in playing the same electronic gaming machine as it offers multiple jackpots that can be won.

The parameter boxes 32a to 32e indicate the parameters that must be fulfilled for the player to win each of the jackpots 30a to 30e. Typically the parameters are predetermined combinations of game symbols 10 that appear in the symbol positions 13 of player-selected pay lines 14. In the embodiment, the parameter boxes 32a to 32e indicate that a five of a kind of different types of game symbols 10 must appear on a player-selected pay line 14 in order to win each of the jackpots 30a to 30e. For example, parameter box 32a requires five star symbols to win the jackpot 30a, parameter box 32b requires five diamond symbols to win the jackpot 30b, parameter box 32c requires five heart symbols to win the jackpot 30c, parameter box 32d requires five spade symbols to win the jackpot 30d and parameter box 32e requires five club symbols to win the jackpot 30e.

There are also bonuses 33a, 33b, and 33c of lesser value than the jackpots 30a to 30e which are displayed below the jackpots. For example, five of a kind of any item or picture-based symbol 10b using a wild card or substitute W symbol 10c on a player-selected pay line 14 will award the bonus 33a amounting to $250. Five of a kind of any playing card symbol 10a on a player-selected pay line 14 will award the bonus 33b amounting to $40. Finally, five of a kind of any playing card symbol 10a using a wild card or substitute W symbol 10c on a player-selected pay line 14 will award the bonus 33c amounting to $10. The amounts of the bonuses 33a, 33b, 33c are static or fixed, but in other embodiments also have current values that include a start up value and an incremented value. Generally, the start up values of the bonuses 33a to 33c are less than the start up values of the jackpots 30a to 30e.

The bonus 33c has a lesser value than the bonus 33b as a substitute or wild card W symbol 10c is required to achieve the bonus. Similarly, the bonus 33a has a lesser value than any of the jackpots 30a to 30e as a wild card W symbol 10c is required to win the bonus. This is because the jackpots 30a to 30e each requires a “pure” combination that does not rely on a substitute or wild card symbol 10c to achieve the five of a kind combination that is permitted for the bonus 33a.

In addition, the jackpots 30a to 30e are of higher value than the bonuses 33a to 33c as the parameters (i.e. the winning combinations of game symbols 10) for winning a particular jackpot are more difficult for the player to achieve compared to the bonuses. For example, only one combination of game symbols 10b is associated with each jackpot 30a to 30e (only a combination of five star symbols 10b and the trigger symbol 15 are associated with jackpot 30a, only a combination of five diamond symbols and the trigger symbol 15 are associated with jackpot 30b, etc.), whereas five possible combinations are associated with bonus 33b (five of any playing card symbol 10a with the trigger symbol 15). Likewise, bonuses 33a and 33c are associated with many more combinations as from one to four of the game symbols can be substituted for by the W wild card symbol 10c. Thus, there is a clear distinction between the jackpots 30a to 30e and the bonuses 33a to 33c in terms of both value and probability of achieving the jackpot/bonus. In other embodiments, the jackpots 30a to 30e are associated with two winning combinations instead of just one combination to increase the chances of winning one of these jackpots.

Also, each of the jackpot/bonus winning combinations is uniquely associated with their respective jackpots 30a to 30e and bonuses 33a to 33c. In other words, each jackpot/bonus winning combination is only associated with one of the jackpots/bonuses.

This can also extend between the jackpots 30a to 30e. For example, the player will win the jackpot 30c (having a current value of $3,049.25) instead of the jackpot 30a (having a higher current value of $5,100.50) if the five of a kind combination is composed only of heart symbols 10b, together with a trigger symbol 15, as the reel strips may have less occurrences of star symbols compared to heart symbols and thus the five of a kind of star symbols is statistically more rare than five of a kind of heart symbols.

In the base game 8, the player initially makes a bet using vending slots 5 initiate play of the electronic gaming machine 1 to build up credit to play the base game on the electronic gaming machine. The player can bet or wager monetary amounts equivalent to a particular amount of credits, depending on the bet denomination selected for the base game. For example, the player can bet or wager 50 credits to play 10 pay lines or 200 credits to play 50 pay lines. Also, the player can make any additional side bets or ante-bets to access additional features in the base game 8, such as increasing the number of winning combinations in the game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc. The electronic gaming machine 1 also offers a variety of bet denominations of 1¢, 2¢, 5¢ and 10¢ for the base game 8.

Typically, the electronic gaming machine has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the electronic gaming machine has not yet been played or has been started up, the default bet denomination is initially selected by the electronic game controller 4. The default bet denomination can be randomly selected or chosen according to a predetermined order. Typically, the electronic game controller 4 will select the bet denomination with the lowest value that is available for the base game 8, which would be the 1¢ bet denomination for this embodiment. The default bet denomination can be shown on a bet denomination button (not shown) in the lower screen area 7a to indicate its current status. The player may change the bet denomination at any time in the base game 8 by touching the denomination button before or after the reels 12 have spun.

The electronic game controller 4 then transmits a signal to the display 7 so as to cause the reels 12 to appear to visibly rotate or “spin” in a linear path, typically in a downward vertical direction, and randomly display the game symbols 10 in each symbol position 13 for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 10 can also be provided. If so, the gaming machine 1 enters a winning game state and awards a prize according to the displayed predetermined winning combination.

The electronic game controller 4 also determines whether one of the jackpots 30a to 30e have been won in the base game 8 and electronic game controller will transmit a signal to the video screen 7 to cause the jackpot that is won to be awarded to the player. In this embodiment, the jackpots 30a to 30e are won where a specific combination of game symbols 10 appears in the player-selected pay lines 14, as outlined in the message boxes 33aa, 33b, and 33c. For example, as best shown in FIG. 3, the player will win one of the jackpots 30a to 30e if there is a five of a kind of any of the item or picture symbols 10b and a trigger symbol 15 in the player-selected pay lines 14, as noted in message box 32a. If a wild card W symbol 10c substitutes for one of the item or picture symbols 10b, the bonus 33a will be awarded to the player. Likewise, the bonus 33b will be won by the player if there is a five of a kind of any of the playing card symbols 10a and a trigger symbol 15 in the player-selected pay lines 14, as noted in message box 32b. Finally, the bonus 33c will be won by the player if there is a five of a kind of any of the playing card symbols 10a using a wild card W symbol 10c and a trigger symbol 15 in the player-selected pay lines 14, as noted in message box 32c.

It will be noted that the trigger symbol 15 appearing on the special reel 16 and on a player-selected pay line 14 is a necessary condition for the player to win the jackpots 30 and bonuses 31. Hence, a player that achieves a five of a kind combination without the trigger symbol 15 will not “trigger” the jackpots 30a to 30e. While the trigger symbol 15 appears in the symbol positions 13 on the special reel 16, in other preferred forms, the trigger symbol may simply appear anywhere on the reels 12 of the array 11. In some embodiments, the probability of the trigger symbol 15 being displayed is proportional to a bet made by the player to play the game 8.

In other embodiments, the parameters of the jackpots 30a to 30e are adjustable and the adjustment in the parameters is indicated in the parameter boxes 32a to 32e. In this case, the symbols shown in the parameter boxes 30a to 30e are changed to other game symbols to indicate the change in the parameters of the jackpot winning conditions to the player. Thus, this confers additional variety in game play as the jackpot winning conditions can be adjusted to create more excitement in playing the game 8 on the electronic gaming machine 1. In particular, the adjustment can be made in response to either in-game trigger events that will favour the player, the playing history of the player on the same game, the player profile, the paying history of the game or a combination of any two of these factors.

Also, in other embodiments, the bet denomination for the base game 8 can be changed at any time by touching or selecting a denomination button on the lower screen 7a during the game but only before or after the reels 12 have spun. This results in the bet denomination images (not shown) corresponding to their associated bet denominations appearing on the display 7 for selection by the player. This ensures that the player does not have to navigate through any menus or stop playing the game in order to change the bet denomination. The player can then change the bet denomination by touching the desired denomination image, in response to which a confirmation pop-up message (not shown) appears over the array 11, as mandated by current regulatory requirements, requesting the player to confirm the change of the base bet denomination using “yes” and “no” buttons. If the player changes his or her mind, he or she may touch a “return to game” button (not shown) to continuing playing the base game 8. Alternatively, all the possible bet denomination images can be shown continuously on the display screen 7 above the denomination button during play of the base game 8.

When one of the jackpots 30a to 30e is won, the display 7 shows a suitable animation sequence announcing the award of the won jackpot to the player. The animation sequence comprises a visual display accompanied by suitable sounds and/or music to visually and aurally indicate the award of the jackpots 30a to 30e. The award of the jackpots can be indicated to the player in a number of ways other than described in relation to this embodiment. For example, the parameter and/or prize boxes of the winning jackpot 30a to 30e can be animated or a separate indicator symbol or image can appear on the display 7 to direct the player's attention to the prize box 33a to 33e of the winning jackpot 30a to 30e. Other ways include changing colours, playing an animated or video sequence over the reels 12, with or without music and/or sound effects, and an aural announcement informing the player of the bonus prize change. It will be appreciated that other variations on the above described ways of indicating the award of one of the jackpots are within the scope of the invention.

Also, it will be appreciated that the monetary amounts in the prize boxes 33a, 33b, 33c, 33d, 33e for the jackpots 30a to 30e are not static but are dynamic in nature. In this embodiment, the jackpots 30a to 30e are progressive jackpot prizes in that as the base game 8 is played on the electronic gaming machine 1, a portion of each bet is taken and added to each jackpot 30 and bonus 31 to gradually increase the monetary amount displayed in each respective prize box 33a, 33b, 33c, 33d, 33e until the jackpot 30a to 30e is won. Then the jackpot or bonus is reset to its base or start up monetary value from which it again increases incrementally as bets are made on the electronic gaming machine 1. In other embodiments, the jackpots 30a to 30e are not progressive but increase by a fixed amount after a predetermined amount of playing time has passed.

In addition, the electronic game controller 4 randomly determines whether a predetermined trigger event has occurred which triggers the feature game on the electronic gaming machine 1. In the embodiment, the feature game is triggered by the appearance of three T symbols 10d in any of the symbol positions 13 of the reels 12 on the player-selected pay lines 14. In other embodiments, the trigger event is the appearance of three T symbols 10d anywhere on the reels 12 without having to be on a player-selected pay line 14; i.e. the T symbols 10d act as scatter symbols in this instance. In response to the feature game trigger event of three T symbols 10d, the electronic game controller 4 transmits a signal to the video screen 7 to cause the feature game to appear on the video screen 7. The feature game also uses the same game symbols 10 as the base game, as well as the same array 11, reels 12, symbol positions 13 and player-selectable pay lines 14 on the video screen 7.

The change to the feature game removes the jackpots 30a to 30e from play and replaces them with other bonus prizes, since there is usually no opportunity to change the bet denomination during the feature game. However, it will be appreciated that in other embodiments, the jackpots 30a to 30e are retained for the feature. In a further preferred form, a portion of the jackpots 30a to 30e is used in the feature game and added to the remainder upon the electronic gaming machine 1 returning to the base game 8. In other preferred forms, the invention is applied only to a feature game. In this case, the invention would work in the same way as described in relation to the base game 8.

In the feature game, a predetermined number of free plays or spins of the feature game are awarded to the player. It will be understood by those skilled in the art that a free spin involves a play of the game without requiring any bet to be made by the player, and that any number of free spins can be chosen for the feature game. In addition, it will be appreciated that in the art free spins are commonly referred to as “free games”. In this case, the reels 12 in the feature game are spun without requiring the player to make a bet, unlike the base game. The number of free spins left in the feature game is indicated in a counter in the lower display area 7a. The feature game would operate in a similar manner to the base game 8, where the reels 12 visibly rotate and display randomly selected game symbols 10 in each symbol position 13. Predetermined winning combinations of randomly selected game symbols 10 in the reels 12 of the feature game would also result in the award of prizes to the player, usually of an enhanced value compared to the prizes awarded in the base game. This would also extend to the jackpots 30a to 30e where they are retained for the feature game.

While the preferred embodiment has been described in relation to fixed and progressive jackpot-type bonus prizes in relation to a single electronic gaming machine 1 (also known as standalone jackpot or bonus prizes), it will be appreciated that the invention is applicable to multiple electronic gaming machines linked together as a gaming system. For example, the jackpots 30 can be progressive bonus prizes that are configured to be part of a wide area or in-house link progressive jackpot. In other words, the progressive jackpot can be awarded on a group of networked gaming machines in a specified area or a group of specified electronic gaming machines that are linked together for jackpot purposes. In this case, there is a central jackpot or bonus prize controller that is in electronic communication with the electronic game controllers 4 of each linked electronic gaming machine 1 that monitors and controls the award of the jackpots 30 and bonuses 31. However, the individual electronic game controllers 1 would each control the changes to the bonus prizes in response to the selected bet level and communicate these changes to the central bonus prize controller.

Also, the invention is applicable to electronic gaming machines that provide a plurality of games, so-called multi-game gaming machines. In this instance, there can be one or more bonus prizes associated with each game or a plurality of bonus prizes where only one or some are shared by two or more games. This can also apply where there is a plurality of electronic gaming machines linked together as described above. That is, one or more bonus prizes are shared across several or all the linked electronic gaming machines, and this may occur for only one, some or all of the games offered on each electronic gaming machine.

While the same game format can be essentially used across the base game and feature game, it will be appreciated that the game format may vary across both the base game and feature game. For example, the feature game could adopt a different format of cells and/or use an entirely different set of game symbols, or a mixture of game symbols from the base game and different game symbols. In another example, the base game may be a wheel-type game or a four reel game and the feature game may be a standard five reel game. Similarly, the base game and feature game may each have different game symbols, game rules and pay tables that are unique to each game. Also, the arrangement of the base game 8 and the feature game is not limited to a set of reels or columns, but could take other forms, such as non-rectangular arrays (i.e. arrays that do not comprise rows and columns). For example, where the array is circular, the predetermined game positions can take the form of pie-shaped slices or wedges.

In another preferred form, there is no need for a trigger event in the form of the appearance of a predetermined number of trigger symbols, such as the scatter symbols 10d. Instead, the electronic game controller 4 can internally determine when to trigger the feature game in the base game. One way to implement this preferred form is for the electronic game controller 4 to internally generate a random number and checks if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur in the base game and activating the feature game. This random number generation can also be used by the electronic game controller 4 to determine whether the player has won one of the jackpots in the base game 8. This type of trigger for the bonus prize is commonly referred to as a mystery jackpot. That is, none of the symbols in the game trigger the jackpot; hence the triggering event is a “mystery”.

Another method for triggering the jackpots 30a to 30e, which is preferably applied to the embodiment of FIG. 3, will now be described in more detail below. The electronic game controller 4 determines a predetermine jackpot value in a predetermined range of values for displaying a predetermined combination of game symbols 10, 15 on the reels 12, 16 corresponding to a jackpot winning combination and a bet value corresponding to accumulated total of bets. This takes the form of a jackpot meter where the level of the jackpot meter equates to the bet value and is compared against the jackpot value to determine whether the jackpot is awarded and the jackpot winning combination is displayed on the reels 12, 16. The jackpot is awarded where the level of the jackpot meter is equal to or exceeds the jackpot value. The jackpot value can be preset or the electronic game controller 4 can randomly select a jackpot value for the jackpot meter.

The minimum and maximum values of the jackpot meter are monetary values related to the accumulated total of bets. The minimum value is the initial monetary value which initiates whether the electronic game controller decides to award a jackpot. In an alternative embodiment, the minimum value of the jackpot meter corresponds to the initial or start up value of the jackpot. The maximum value is the upper limit of the jackpot meter so that once the jackpot meter reaches the maximum value, the jackpot is automatically triggered to be won.

The jackpots 30a to 30e each have their own jackpot meters and run parallel to each other in the base game 8. That is, the probability of winning each jackpot 30a to 30e can be made independent of each of the other jackpots by varying the minimum and maximum values of their respective jackpot meters. For example, a player may win jackpot 30a and not any of the other jackpots 30b to 30e or the player may win two or of the jackpots 30a to 30e at the same time.

For each bet made to play the base game 8, the electronic game controller 4 calculates an increment of each bet by multiplying the bet by an increment rate and adds the increment to the jackpot meter. The increment rate is typically as fixed percentage but in other embodiments, the increment rate is a non-linear function of the bet instead of a percentage.

The electronic game controller 4 then checks the jackpot meter to see if it is equal to or greater than the minimum value. If the minimum value has not been reached, then the electronic game controller 4 does not determine whether to award the jackpot and causes the display of game symbols 10 on the reels 12 and the non-display of the trigger symbol 15 on the special reel 16. If the jackpot meter is greater than the minimum value, the electronic game controller 4 then checks to see if the level of the jackpot meter is equal to or is greater than the jackpot value. If so, then the electronic game controller 4 causes the display of the relevant winning combination of symbols required by the parameter box 33a to 33e to award the jackpot 30 to the player. Once one of the jackpots 30a to 30e has been won, the jackpot meter is reset to the minimum value and increments are added for each play of the base game 8 to increment the level of the jackpot meter. Thus, unlike conventional electronic gaming machines that display combinations of jackpots grouped together with common start up values, dependent reset values and progressive increments, the preferred embodiment of the invention provides for individual displays for each jackpot combination that are independent of each other in terms of the start up value and increment rate (and hence increment value). As a result, the preferred embodiments provide a greater variety of jackpots, jackpot values and playing winning jackpots, especially being able to independently win jackpots as they are no longer tied together in terms of increment rate and start up value. Moreover, the display of individual jackpots and their associated parameters and current values enables players to clearly distinguish between jackpots and their relative values, thus heightening interest in playing the electronic gaming machine 1.

In some embodiments, the jackpot and/or bonus prizes include fixed jackpots, mystery jackpots and symbol driven jackpots. Also, in other embodiments, there is a mixture of progressive jackpots, fixed jackpots, mystery jackpots and symbol driven jackpots offered by the electronic gaming machine 1.

In other embodiments, a separate trigger event can be used to award the progressive jackpot prize, such as a special jackpot symbol, a trigger event internally generated by the electronic game controller. Alternatively, or additionally, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some embodiments, the jackpot and/or bonus prizes are shared between electronic gaming machines linked together.

While one embodiment of the invention has been described in relation to a base game and a feature game, it will be appreciated that the invention could include one or more additional feature games that are triggered by specific trigger symbols appearing in the feature game. Also, the additional feature games may also have trigger symbols that trigger further feature games in a cascading fashion. These additional and further feature games could have the same game play elements as the feature game or be different feature games entirely.

Furthermore, the embodiments of the invention have been described as providing effectively a 6×3 set of reels 12 for the base game 8, being the standard 5×3 reel set with the special reel 16. However, it will be appreciated that in other embodiments, the size and shape of the reels 12 can vary. For example, a standard 5×3 set of reels 12 can be used, in which case the trigger symbol 15 would only appear in the rightmost reel or column of the array 11. In another example, the array 11 could take any number of different shapes, such as triangular, circular, square, hexagonal, hemi-spherical or other polygonal shapes. Alternatively, the arrays 11 could have an unequal number of rows and/or columns. For example, the reels 12a, 12b could have three rows, but the reels 12c to 12e could have four rows. Also, the trigger symbol 15 can appear in any one of the reels 12a to 12e or a designated reel in the array 11, and not the rightmost reel.

Also, in a further preferred form, the player can selectively stop spinning of the reels 12, either individually or collectively, to increase player interaction and provide the player with an opportunity to guess when a desirable game symbol may appear in a symbol position 13 that results in a desired prize or game enhancing element. Furthermore, the player can start spinning of the reels 12, either individually or collectively, to further enhance player interaction.

In other preferred forms, the base game 8 (and the feature game) need not be displayed on a single video screen 7. Instead, they may be displayed on separate video screens, with the lower playing area 7a appearing in a lower video screen and the information display area 7b on an upper video screen. In other preferred embodiments, the base game 8 and feature game need not be displayed only on the lower video display screen 7a, but can be extended to the upper video screen 7b. Also, the order can be reversed, with the playing area 7a appearing on an upper video screen or upper part of a single video display screen 7 and the information display area 7b appearing on a lower video screen or lower part of a single video display screen.

In another preferred form, the video screen 7 is a touch screen for use in addition to the player-actuatable buttons 5 so as to enable the player to select the bet level (such as bet denominations or bet per pay line 14) as well as other various features, such as making monetary bets for the game, initiating play of any base and feature games played and responding to any messages or requests issued on the electronic gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10 may appear in the reels 12

In other preferred forms, the bonus prizes are shared with any other games offered on the electronic gaming machine (as in multi-game gaming machines). In another preferred form, only one of the bonus prizes changes in response to the selected bet level to further emphasise that particular bonus prize. This can be extended to electronic gaming machines linked together

Also, the bonus prize can be won other than achieving a particular combination of game symbols 10 as described in relation to FIGS. 3 to 6. Instead, specific bonus prize symbols could be used that must appear anywhere on the player-selected pay lines 14 or on the same pay line 14 to win the bonus prize.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the game or by providing a suitable menu button on screen during play of the game.

In another aspect, the invention includes a computer program configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

In other embodiments, the electronic gaming machine 1 also offers the player the opportunity to play in community games against other players in so-called tournament games, or even in player versus player games. This is typically implemented by electronically linking several electronic gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in said selected available jackpot set.

In other embodiments of the invention, the base game 8 or the feature game may include game enhancing symbols that confer game enhancing elements. The award of game enhancing elements can be done by way of a sixth reel or the appearance of game enhancing symbols in the reels 12a to 12e.

The types of game enhancing elements include fixed monetary prizes, “Held Reels”, “×10 Multiplier” (applicable to the prize awarded by the base game for the five of a kind trigger combination and/or to the total amount of the bet or credits bet per pay line), “10 Free Spins/Games”, progressive symbols and changing the function of a standard game symbol 10a, 10b into a substitute symbol in addition to any displayed substitute Dragon symbols 10c. Held columns or reels typically involve the column or reel to only display wild/substitute symbols, thus enhancing the probability of achieving a predetermined combination. Progressive symbols award a prize is awarded upon a certain number of progressive symbols are accumulated by the player over a number of games played on the gaming machine. Other examples include:
i) symbols that award a predetermined number of free plays of said game, such as 8, 10 or 15 free spins or games;
ii) win multiplier symbols that multiply the amount of any win from one of said predetermined winning combinations;
iii) “wild” symbols that cause the display of substitute symbols in randomly selected symbol positions;
iv) bonus symbols that awards a bonus prize, either as a monetary amount or as a bonus credit;
v) wild multiplier symbols that cause the display of substitute symbols on the array 11 and multiplies the amount of any win from one of said predetermined winning combinations;
vi) bonus wild symbols that cause the display of substitute symbols on the array 11 and awards a bonus prize;
vii) symbols that cause the award of additional free plays of said game;
viii) symbols that cause one or more of said symbol positions to be held static (typically one or more reels 12a to 12e) and display substitute symbols on the array 11;
ix) symbols that cause the same game symbol to be stacked in a group of symbol positions, typically the group being one or more reels 12a to 12e;
x) symbols that cause the display of new game symbols on the array 11;
xi) “reveal” symbols that cause a game symbol to reveal another game symbol;
xii) “replacement” symbols that cause one or more game symbols to be replaced by other game symbols in the array 11;
xiii) Bonus Prize of 5× bet, 10× bet or 25× bet (the total amount of the bet or credits bet per pay line);
xiv) All royal card symbols change to wilds (substitute symbols) on reels 2, 3 and 4 (i.e. reels 12b, 12c and 12d) of the array 11;
xv) All picture symbols change to wilds on reels 2, 3 and 4 (i.e. reels 12b, 12c and 12d) of the array 11;
xvi) All symbols on reels 2 and 4 (i.e. reels 12b and 12d) of the array 11 change to wild symbols; and
xvii) All symbols on reels 1 and 5 (i.e. reels 12a and 12e) of the array 11 change to wild symbols.

These game enhancing symbols do not modify the function or value of the game symbols 10 that appear on the arrays 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun array 11. In another embodiment, the game enhancing symbols may indicate the duration in which its game enhancing element is applied, such as a predetermined number of spins or a predetermined time period.

In other preferred embodiments, additional game enhancing symbols include the award of points or tokens that lead to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

It will further be appreciated that any of the features in the preferred embodiments of the invention can be combined together and are not necessarily applied in isolation from each other. For example, the feature of the player being able to selectively starting or stopping spinning of the reels 12 and the feature of providing a multiple games having different array formats can be combined into a single electronic gaming machine. Similar combinations of two or more features from the above described embodiments or preferred forms of the invention can be readily made by one skilled in the art.

By providing different levels of bonus prizes and associating those levels with the probability of achieving the bonus prizes via the number of prize winning combinations, the invention increases the player's interest and participation in the electronic gaming machine as the player sees a direct connection between the bonus prizes and their win parameters. This is further increased in some embodiments by indicating the current value of the bonus prize and the bonus prize parameters. Also, in some embodiments, indicating the bonus prize values and associated parameters for winning each bonus prize, the invention allows players to easily determine what is needed to win a bonus prize and its current value. In particular, in one embodiment, this advantage is further enhanced allowing the bonus prize parameters to be adjusted and indicating that adjustment on the electronic gaming machine to the player. Moreover, the display of individual jackpots enables the jackpots to be independent of each other in terms of their win probability, start up value and increment rate, thus providing a variety of game play. All these advantages of the invention result in the player being more likely to retain interest in continuing to play the same electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a housing having a display for displaying game symbols for playing a game and an electronic game controller in electronic communication with said display for controlling the appearance of game symbols in said game on the display, wherein said game comprises randomly displaying said game symbols and awarding prizes to a player for predetermined winning combinations of game symbols to a player; and
an input device for receiving commands from said player to operate said electronic gaming machine and initiate play of said game on said display, said input device being in electronic communication with said electronic game controller;
wherein said electronic game controller in response to a command from said player via said input device commences play of said game by randomly selecting game symbols and transmitting a signal to said display to display said randomly selected game symbols;
wherein said electronic game controller causes at least four bonus prizes to be associated with said electronic gaming machine, said bonus prizes being awarded upon the appearance of predetermined bonus prize combinations of game symbols; and
wherein a first group of bonus prizes comprises two of said bonus prizes, each said bonus prize of said first group being awarded upon the appearance of one or two of said bonus prize combinations and wherein a second group of bonus prizes comprises two or more of the bonus prizes, each said bonus prize of said second group being awarded upon the appearance of any one of three or more of said bonus prize combinations, each of said bonus prize combinations being associated with only one of said bonus prizes.

2. The electronic gaming machine of claim 1, wherein each said bonus prize combination comprises a predetermined number of the same game symbol and a jackpot trigger symbol.

3. The electronic gaming machine of claim 1, wherein one of said bonus prize combinations comprises at least one wild card symbol.

4. The electronic gaming machine of claim 1, wherein one bonus prize of said first group is awarded only upon the appearance of one of said bonus prize combinations.

5. The electronic gaming machine of claim 4, wherein all of said bonus prizes of said first group are awarded upon the appearance of only one of said bonus prize combinations.

6. The electronic gaming machine of claim 4, wherein at least two bonus prizes in said second group is awarded upon the appearance of any one of five or more bonus prize combinations.

7. The electronic gaming machine of claim 1, wherein the probability of said jackpot trigger symbol being displayed is proportional to a bet made by said player to play said game.

8. The electronic gaming machine of claim 1, wherein each said bonus prize has a current value, said current value comprising a start up value and an incremented value, said incremented value increasing by a predetermined increment amount with each play of said game.

9. The electronic gaming machine of claim 8, wherein said predetermined increment amount is calculated according to a percentage of each bet made to play said game.

10. The electronic gaming machine of claim 8, wherein said bonus prizes have individual start up values and predetermined increment amounts.

11. The electronic gaming machine of claim 10, wherein at least two of said bonus prizes have different start up values and predetermined increment amounts.

12. The electronic gaming machine of claim 10, wherein said bonus prizes in said first group have start up values greater than the start up values of the bonus prizes in said second group.

13. The electronic gaming machine of claim 8, wherein said electronic game controller causes the display of the current value of said associated bonus prize.

14. The electronic gaming machine of claim 13, wherein said electronic game controller causes the display of the bonus prize combinations for each said bonus prize.

15. The electronic gaming machine of claim 1, wherein said bonus prizes of said first group are progressive jackpot prizes and said bonus prizes of said second group have fixed values.

16. The electronic gaming machine of claim 1, wherein said bonus prizes of said first group have fixed values and said bonus prizes of said second group are progressive jackpot prizes.

17. The electronic gaming machine of claim 1, wherein said bonus prizes of said first group and said second group have fixed values.

18. The electronic gaming machine of claim 1, wherein said game symbols are arranged into an array of reels and said jackpot trigger symbol only appears in one of said reels.

19. The electronic gaming machine of claim 18, wherein there are five reels and said jackpot trigger symbol only appears in the rightmost reel of said array.

20. The electronic gaming machine of claim 18, wherein there are six reels and said jackpot trigger symbol only appears in the rightmost reel of said array.

21. The electronic gaming machine of claim 1, wherein at least one of said bonus prizes is one of a jackpot prize, a progressive jackpot prize or a mystery bonus prize.

22. The electronic gaming machine of claim 1, wherein said electronic gaming machine provides a plurality of said games and at least one of said bonus prizes is shared by two or more of said games.

23. The electronic gaming machine of claim 22, wherein all of said bonus prizes are shared by two or more of said games.

24. A gaming system comprising a plurality of electronic gaming machines of claim 1, wherein said electronic gaming machines are in electronic communication with each other and said bonus prizes are associated with at least one game of each said electronic gaming machine.
